(19) United States
(12) Patent Application Publication
(10) Pub. No.: US 2024/0238649 A1
(43) Pub. Date: Jul. 18, 2024

(54) Golf Ball With Particulate-Coated Layer

(71) Applicant: OnCore Golf Technology, Inc., Buffalo, NY (US)

(72) Inventors: John Calabria, Easley, SC (US); Douglas P. DuFaux, Orchard Park, NY (US); Michael D. Jordan, Waxhaw, NC (US); Keith Allen Blakely, Buffalo, NY (US)

(73) Assignee: OnCore Golf Technology, Inc., Buffalo, NY (US)

(21) Appl. No.: 18/381,619

(22) Filed: Oct. 18, 2023

Related U.S. Application Data
(60) Provisional application No. 63/416,949, filed on Oct. 18, 2022.

(51) Int. Cl. A63B 37/00; C08L 75/04

(52) U.S. Cl. CPC A63B 37/0076; A63B 37/0037; A63B 37/0049; A63B 37/0069; A63B 37/0026; A63B 37/0039; A63B 37/0083; A63B 2209/02; C08L 75/04

(57) ABSTRACT

A golf ball with one or more cover layers having an outer surface defining a plurality of dimples, one or more spherical core layers and one or more mantle layers superposed about the core layer. Each of the cover, core and mantle layers has a flexural modulus range of values. A particulate material layer is disposed onto the surface of one or more of the cover layer(s), the core layer(s) and the mantle layer(s). The particulate materials are comprised of a mixture of at least one from the group including metal, polymer, rubber, ceramic, and composite materials along with at least one adhesive compound. The particulate material layer(s) provide perimeter weighting for the golf ball layer onto which they are disposed. The particulate material layers(s) are formulated to have flexural moduli values that transition between the flexural moduli values of the golf ball layers between which the particulate material layer(s) are positioned.

### CROSS-REFERENCE TO RELATED APPLICATIONS

This is a regular utility patent application that claims the benefit of U.S. Provisional Application Ser. No. 63/416,949, filed Oct. 18, 2022, the contents of which are incorporated in their entirety herein by reference.

### FIELD OF THE DISCLOSURE

The disclosure relates to an improved multi-piece golf ball that includes at least one layer having weighted particulate materials disposed onto the surface thereof and at least one additional layer disposed over the particulate material to provide improved playing characteristics. The particulate material layer has an elastic modulus that transitions between the elastic modulus of the layer over which the particulate layer is placed and the layer placed over the particulate material layer.

### BACKGROUND OF THE DISCLOSURE

A wide variety of multi-layer golf ball constructions have been proposed in recent years, including some that contain powder metals and plastic materials mixed therein. Often, these materials are embedded into plastics and/or rubber materials through traditional compounding methods and are used to produce one or more layers of a golf ball.

Some proposed processes for manufacturing such multi-layer golf balls have been limited in use due to expensive manufacturing costs, unreliable manufacturing processes, poor playing-performance characteristics, and poor durability of certain layers. The normal force at impact between a golf ball and a golf club when the average golfer strikes the ball can be on the order of 2000 lbs. per square inch. Even impact forces of shots closer to the green can cause golf-ball integrity and performance issues when done repeatedly. Thus, any processes used to produce golf balls must be able to produce robust, high-quality layers able to withstand many impacts.

Until recent years, most commercially-available golf balls have been two-piece or three-piece designs. Two-piece balls are typically comprised of a solid elastomeric core and a cover formed from a variety of materials such as Surlyn® and polyurethane. Historically, three-piece balls are comprised of a central core, which may be solid or liquid filled, surrounded by a middle layer formed from polymeric material and a cover, or include a large diameter core and a two-layer cover. Three-piece balls also include wound balls, although this type of ball is no longer commercially available from major manufacturers. More recent designs, however, include a wide range of materials and additional layers, including four-piece and five-piece balls with many of the multi-piece designs focusing on the construction and performance of the layers near the cover layer. Each of these layers will have an elastic modulus value directly related to the compositions used to make the layer. Two adjacent layers can have widely differentiated elastic modulus values. These values directly impact the playing characteristics of golf balls.

Independent of configuration, most commercially-available golf balls are made of nonmetallic materials such as elastomers, ionomer resins, polyurethanes, polyisoprenes, and nylons. Except for wound balls, these balls are made by injection molding and/or compression molding one layer around the core and/or around another layer. In order to obtain optimum playing characteristics, such as spin control and improved accuracy (i.e., fewer hooks and slices without sacrificing distances), golf ball designs and their materials of manufacture are becoming increasingly complicated but are limited by the range of materials and type of materials selected for construction.

One way in which golf balls have been modified to improve playing characteristics is to enhance perimeter weighting. This has been accomplished by adding heavy-weight fillers such as Tungsten to the formulations of one or more layers of a golf ball. Addition of heavy-weight fillers to specific layers of a golf ball is an effective way to enhance perimeter weighting, however, the amount of heavy-weight filler added can impact the performance characteristics of the layer. To avoid this problem and still provide enhanced perimeter weighting, heavy-weight filters have been added as a coating to one or more layers of a golf ball. This enables the discrete layers to maintain their performance characteristics while adding the enhanced perimeter weighting.

What has not been addressed is the problem associated with what can be a large disparity in the elastic modulus of adjacent layers. Cast and TPU cover materials often have a flexural modulus in the range of 10,000 to 30,000 psi. In contrast, mantle layers in three-piece golf balls can have a flexural modulus in the range of 55,000 to 70,000 psi. This disparity in flexural modulus between layers is difficult to bridge without dramatically altering the formulations of the layers, which will ultimately impact the performance characteristics of the layers. Any attempt to modify the layer formulations to bring the flexural moduli closer together will inevitably impact the playing characteristics of the layers that have otherwise been optimized. Because of these and other shortcomings, there is a need for golf balls that include flexural modulus transition layers that can perform the dual function of enhancing perimeter weighting and provide a flexural modulus that bridges the gap between adjacent golf ball layers. Furthermore, there is a need for combinations of layer designs, materials, and production techniques that allow such golf balls to be produced in large quantities at a cost that supports commercial success.

### SUMMARY OF THE DISCLOSURE

In one aspect of the disclosure, golf balls produced in accordance with the disclosure include a cover layer having an outer surface defining a plurality of dimples and an inner surface opposite the outer surface. A spherical core having an outer surface is disposed within the cover layer. Particulate material is disposed onto the surface of the spherical core as an additional layer, wherein the particulate material is comprised of a mixture having at least one component selected from a group of metal, polymer, rubber, ceramic, and composite materials bonded with at least one adhesive compound including aerosolized and/or liquid based adhesive compounds. The particulate material layer is formulated to have a variable flexural modulus from about 30,000 to about 50,000, or a flexural modulus range that bridges a gap between the flexural modulus value of the core and the flexural modulus value of the cover.

In another aspect of the disclosure, golf balls are formed with a cover layer having an outer surface defining a plurality of dimples and an inner surface opposite the outer surface. A spherical core having an outer surface is disposed within the cover layer. A single mantle layer is disposed between the spherical core and the cover. Particulate material is disposed onto the surface of the mantle layer as an additional layer, wherein the particulate material is comprised of a mixture of at least one component selected from the group of metal, polymer, rubber, ceramic, and composite materials bonded with at least one adhesive compound. The particulate material layer is formulated to have a variable flexural modulus from about 30,000 to about 50,000, or a flexural modulus range that bridges a gap between the flexural modulus value of the mantle and the flexural modulus value of the cover.

In a further aspect of the disclosure, golf balls are formed with a cover layer having an outer surface defining a plurality of dimples and an inner surface opposite the outer surface. A spherical core having an outer surface is disposed within the cover layer. A first, innermost mantle layer has an inner surface disposed on the outer surface of the spherical core within the cover layer. A second, outermost mantle layer is disposed between the innermost mantle layer and the cover layer. The innermost mantle layer has an inner surface disposed on the outer surface of the spherical core. The outermost mantle layer has particulate material disposed onto its outermost surface as an additional layer, wherein the particulate material is disposed between the outermost mantle layer and the inner surface of the cover layer. The particulate material is comprised of a mixture having at least one component selected from a group of metal, polymer, rubber, ceramic, and composite materials bonded with at least one adhesive compound. The particulate material layer is formulated to have a variable flexural modulus from about 30,000 to about 50,000, or a flexural modulus range that bridges a gap between the flexural modulus value of the outer mantle and the flexural modulus value of the cover.

In a yet further aspect of the disclosure, golf balls are formed with a cover layer having an outer surface defining a plurality of dimples and an inner surface opposite the outer surface. A spherical core having an outer surface is disposed within the cover layer. Golf balls according to this aspect of the disclosure have at least two mantle layers. A first, innermost mantle layer has a first mantle layer inner surface disposed on the outer surface of the spherical core and a first mantle layer outer surface opposite the first mantle layer inner surface. A second, outermost mantle layer is disposed between the first mantle layer outer surface and the inner surface of the cover layer and has a second mantle layer outer surface opposite the second mantle layer inner surface. One or each of the at least two mantle layers has/have particulate material disposed onto its/their outermost surface(s) as one or more additional layers. The particulate material is comprised of a mixture having at least one component selected from a group of metal, polymer, rubber, ceramic, and composite materials bonded with at least one adhesive compound. The particulate material layer is formulated to have a variable flexural modulus from about 30,000 to about 50,000, or a flexural modulus range that bridges a gap between the flexural modulus value of the core and the flexural modulus value of the cover. These and other aspects of the disclosure will become apparent from a review of the appended drawings and a reading of the following detailed description of the disclosure.

### BRIEF DESCRIPTION OF THE DRAWINGS

It should be understood that the drawings appended hereto are meant purely for illustrative purposes. The drawings are intended to show the cooperation of materials and components and are not to be considered drawn to scale.

FIG. 1 is a cross-sectional view of a golf ball including three material layers: (1) a spherical core layer, (2) a layer of particulate material disposed onto the surface of the core layer forming a particulate layer, and (3) a cover layer in accordance with one embodiment of the disclosure.

FIG. 2 is a cross-sectional view of a golf ball including four material layers from innermost core layer to outermost cover layer: (1) a spherical core, (2) a mantle layer, (3) a layer of particulate material disposed onto the surface of the mantle layer forming a particulate layer, and (4) a cover layer according to another embodiment of the disclosure.

FIG. 3 is a cross-sectional view of a golf ball including five material layers from innermost core layer to outermost cover layer: (1) a spherical core, (2) a first mantle layer, (3) a layer of particulate material disposed onto the surface of the first mantle layer forming a particulate layer, (4) an inner cover layer, and (5) an outer cover layer in accordance with yet another embodiment of the disclosure.

FIG. 4 is a cross-sectional view of a golf ball including five material layers from innermost core layer to outermost cover layer: (1) a spherical core, (2) a first mantle layer, (3) a second mantle layer, (4) a layer of particulate material disposed onto the surface of the second mantle layer forming a particulate layer, and (5) a cover layer according to a further embodiment of the disclosure,

FIG. 5 is a schematic view of a golf ball spray coating system used in conjunction with a liquid material that includes pure liquids, liquid mixtures, and particulate materials that form a flowable slurry according to a yet further embodiment of the disclosure.

FIG. 6 is a schematic view of a spray coating system used in conjunction with dry powder materials in accordance with another embodiment of the disclosure.

FIG. 7 is a schematic view of a spray coating system in accordance with yet another embodiment of the disclosure.

### DETAILED DESCRIPTION OF THE DISCLOSURE

In one broad aspect of the disclosure, a multi-layer golf ball has particulate material disposed over at least one layer of the golf ball. The particulate material is comprised of a mixture of particulate materials that collectively or individually have a high density, which for purposes of this disclosure is defined as being from about 2 grams per cubic centimeter (g/cc) to about 20 g/cc. In one embodiment, the particulate material or particulate material mixture is comprised of at least 50% tungsten by weight. In another embodiment, the particulate material is deposited on the outer surface of the layer directly under the cover layer of the golf ball, wherein the cover layer comprises a layer including a dimpled pattern.

Numerous golf ball constructions are possible, including embodiments with a golf ball comprised of at least two conventional layers, a core and a cover. In accordance with the disclosure, a golf ball with two conventional layers has a first layer in the form of a spherical core having an outer surface and a second layer that comprises a cover having an inner surface. Particulate material is disposed onto the outer surface of the spherical core and forms a third intermediary layer. For embodiments having more than two layers, e.g., a core, a mantle and a cover, the particulate material may be applied to the outer surface of one or more of the layers, including the cover. It should be understood that the deposit of a particulate material layer on any layer of a golf ball, (other than the cover layer) will result in the particulate material layer registering against an inner surface of the next layer superposed about the layer to which the particulate material is deposited. By way of illustration and not limitation, the number of layers comprising an embodiment of a golf ball according to the disclosure is limited by manufacturing considerations such as the minimum thickness possible for each layer, the associated fabrication costs, and finally, the regulatory limitations placed upon the dimensional and weight characteristics of a golf ball. In general, particulate coatings can be applied on any or all layers in golf balls having less than 10 layers disposed over a spherical core.

In another aspect of the disclosure, a golf ball is comprised of three layers, a core, a mantle/middle and a cover, with particulate material forming a fourth intermediary layer disposed over an outer surface of a second or middle layer. Such a particulate material layer may form an outer or secondary core layer, an inner or outer secondary mantle layer and/or an inner or outer secondary cover layer. A first, or innermost, layer comprises a spherical core having an outer diameter. In one embodiment, the spherical core is comprised illustratively of polybutadiene rubber or a thermoplastic urethane (TPU). If a TPU is used, Texin 770A or any of the family of Texin polyurethane blends marketed by Covestro AG of Leverkusen, Germany may be used as an illustrative core composition. A second layer is disposed onto and registers against the spherical core such that the inner diameter of the second layer is approximately equal to the outer diameter of the spherical core. The second layer should have a substantially uniform thickness and define an outer spherical surface onto which a particulate material is disposed as the fourth layer. A third layer is disposed over the particulate material/fourth layer and forms the golf ball cover that includes dimples or other features molded into the outer surface to improve aerodynamic performance as is well known in the art of golf balls.

In another aspect of the disclosure, a golf ball comprises a spherical core, a cover layer with a dimpled pattern as the outermost layer, and one or more intermediate layers comprised of polymeric, elastomeric, and/or composite material disposed between the spherical core and the cover layer. Particulate material as a further layer is disposed onto the surface of one or more of the intermediate layers. In one embodiment, the spherical core is a hollow shell made from a high stiffness material. As an illustrative example of a high-stiffness material, the hollow core can be made from 321 stainless steel with a wall thickness from about 0.010 inches to about 0.050 inches. In a further illustrative embodiment, the wall thickness is about 0.040 inches with an outer diameter of about 1.000 inches.

In a further aspect of the disclosure, the golf ball has a cover layer formed of an ionomeric material or another material resistant to damage from external articles and forces of the type normally encountered when playing golf, such as a golf club. In one illustrative embodiment, the cover layer is formed from polyurethane compositions. Broadly, polyurethane, and more specifically, thermoplastic polyurethane compositions are formed from the reactive combination of a polyisocyanate and a polyol. Catalysts, such as dibutyl tin di-2-ethylhexanoate are commonly used to produce the desired polyurethane prepolymer chain. Chain extenders, such as 1,4-butanediol, may be used as well as is known in the art.

Polyurethane materials can be composed of several different types of components. Common thermoset materials used are either polyester or polyether-based with polyether being preferred due to improved properties and better resistance to moisture. The most likely materials to consider are TDI (Toluene Diisocyanate) or MDI (Methylene Diphenyl Diisocyanate) urethanes which can be easily cured with amine curatives that are readily available. Low, free TDIs are good for golf ball covers due to greater processing stability, manufacturing flexibility and highly crosslinked materials for improved durability. MDIs are better for UV resistance. Both can be processed in a range of durometers, e.g., 98 A-100 A, using similar processing conditions. As a non-limiting example, COIM low, free TDI prepolymer could be processed at around 150° F. with an amine curative held at room temperature. Ratios ranging from 10:1 or 5:1 could be used depending on operating parameters. Additionally, a colorant would typically be employed for either TDIs or MDIs to provide good UV resistance for either formulation.

Another acceptable polyurethane material is Adiprene LF TDI, which is a low, free TDI. Ethacure 100 or Ethacure 300 (Albemarle) may be used as the curing agent. Both Ethacure 100 and Ethacure 300 are function as chain-extenders or cross-linker components when mixed with the Adiprene LF TDI.

TDIs or MDIs would be prepped in a closed-loop system after being heated to 150° F. The material is then degassed under vacuum and transported to a mixer where it would be combined with an amine curative (also degassed) and mixed under high shear conditions (high RPMs). The dispensed urethane would have a specific gel time which can be manipulated by temperature of the materials as well as speed of mixing. The gel time would be employed in properly centering the core/mantle to produce a concentric cover applied to the mantled core. Subsequent heating to cure the cover inside the mold and then cooling of the mold to facilitate removal of the molded ball would conclude the process.

In a yet further aspect of the disclosure, the golf ball has a cover layer forming a cover layer outer surface, defining a dimpled pattern, and a cover layer inner surface. The cover layer has a cover thickness between its outer surface and inner surface of from about 0.010 inches to about 0.100 inches. A sub-cover layer, e.g., an intermediate layer, second cover layer, mantle layer, may have a thickness from about 0.010 inches to about 0.25 inches. Alternatively, any intermediate layer, i.e., any layer between a core and a cover or outer cover layer may have a thickness from about 0.030 inches to about 0.600 inches. Whatever thicknesses are used, the combination of all the layers cannot exceed an overall diameter of 1.680 inches.

The ball also includes a spherical core or layer, which has a core outer surface and may have a core inner surface if the spherical core is hollow. The spherical core or layer, with respect to hollow embodiments, has a sphere thickness between its outer surface and its inner surface. The outer surface of the spherical core can be supported or surrounded by a first mantle layer inner surface of a first polymeric, elastomeric, and/or composite mantle layer. The first mantle layer has a first mantle layer outer surface, which can be supported or surrounded by a second mantle layer inner surface of a second polymeric, elastomeric, and/or composite mantle layer. A second mantle layer outer surface of the second mantle layer can be supported or surrounded by the inner surface of the cover layer. Particulate material is disposed onto the outer surface of one or more mantle layers. It should be understood that a golf ball constructed in accordance with the disclosure may include three, four, five, or more polymeric, elastomeric, and/or composite mantle layers between the spherical core layer and the cover layer, and remain within the scope of the disclosure. Each mantle layer may be formed with identical components or each layer may be varied relative to the other mantle layers as to the chemical compositions, concentrations of chemical compositions and layer thicknesses used to construct the layer. Depending upon how many layers are included, more than one layer may be formed from identical mixtures with additional layers formed from different mixtures to provide different response characteristics. Moreover, more than one particulate material layer may be deposited on one of the primary golf ball layers—cover, core, mantle, etc.—with each of the particulate material layers having a different chemical composition, chemical concentration composition and/or layer thickness.

In another aspect of the disclosure, the golf ball includes an electronic device within a hollow spherical core to form a wire core and may include connections between the wire core and any transmitting or receiving devices that require or would include one or more antennas. To provide an antenna for the wire core to enable communications with external wireless communications devices, the particulate material may be deposited in a pattern or other designed structure to function as a transducer to convert radio signals into voltage and vice versa.

For any golf ball constructed in conformance with this disclosure, the golf ball may be designed to meet all of the current performance and construction rules set for golf balls by the United States Golf Association (“USGA”), excluding any rule specifically related to electronic components, if present. Included in the USGA rules, a golf ball must be spherical in shape and have equal aerodynamic properties and equal moments of inertia about any axis through its center. The ball must have a minimum diameter of 1.68 inches (4.267 cm), a maximum weight of 1.620 ounces (45.926 g), a maximum initial ball velocity of 255 feet per second, and travel a limited distance as measured on a standard USGA ball testing machine.

It should be understood that the material sets, polymer layers, and processing conditions used to construct golf balls in accordance with this disclosure may be tailored to achieve the desired play characteristics The response and performance of a finished golf ball is generally related to the combination of materials used in its construction. Each layer of the golf ball will generally contribute to the overall response. That is, the final response or performance will generally be the sum of the responses from the individual layers and any interplay between the layers.

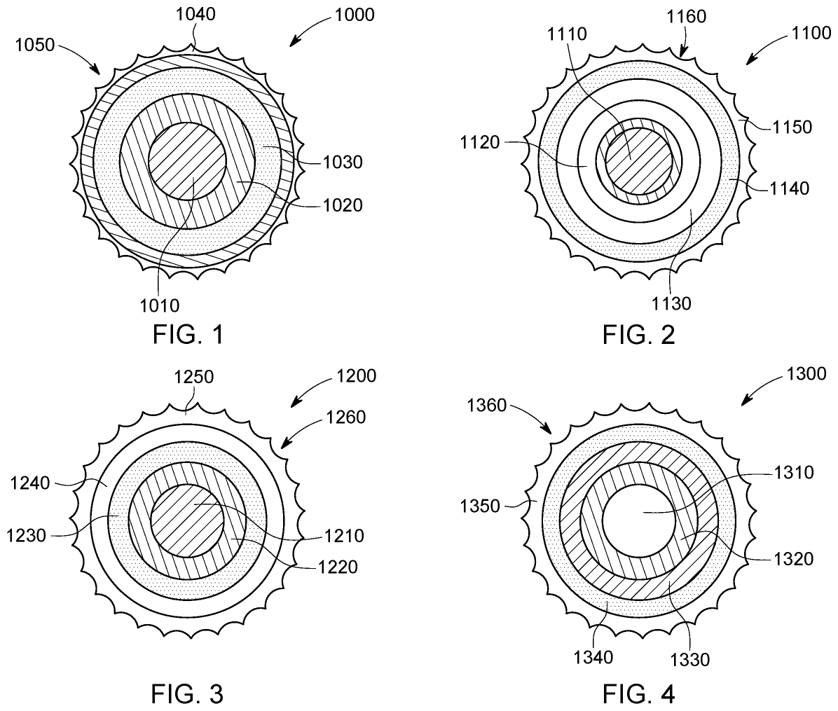

Referring now to FIG. 1, a golf ball designated generally as 1000 includes a spherical core 1010 surrounded by a mantle layer 1020, over which a particulate material is disposed forming a particulate layer 1030, and a cover layer 1040. An outer surface 1050 of cover layer 1040 may include surface features such as dimples and surface coatings to increase flight characteristics and durability, in a nonlimiting, illustrative example.

Spherical core 1010 may be made from a variety of materials and may be solid or hollow. In one embodiment, spherical core 1010 is made from polybutadiene rubber. In other embodiments, spherical core 1010 made be made from a material such as fiber-filled or carbon-filled ABS and/or other hard plastics and filled hard plastics. More specifically, the spherical core can be constructed from any carbon fiber and/or glass filled plastics of any type commonly known in the art such as illustratively, ABS, acetal, acrylic, polyamide, high impact polystyrene, phenolic resin, nylon, polycarbonate, polyester and combinations thereof. Spherical core 1010 has an outside diameter ranging from about 0.50 to about 1.50 inches (about 1.27 to about 3.8 cm). In embodiments where spherical core 1010 is hollow, it may have a thickness from about 0.02 to about 0.16 inches (about 0.05 to about 0.41 cm) or from about 0.02 to about 0.08 inches (about 0.05 to about 0.20 cm), including all values and ranges therebetween.

In accordance with one embodiment of the disclosure, one set of materials that can be used to create high-stiffness cores is a blend of polymers with a secondary material such as ceramics to form a composite. As used herein, “high-stiffness” shall mean an elastic modulus of about 2000 MPa measured at 20° C. Many polymers and ceramics are suitable for this type of composite. Injection molded polymers for the core composites include, but are not limited to, nylon, polyethylene, polystyrene, and acrylonitrile butadiene styrene (ABS). Other materials may be included as the strengthening phase of the polymer matrix composite as well. Illustratively, carbon fiber, carbon nanotubes (CNTs), graphene, and other materials may provide stiffening of the polymer or elastomer when used in a composite as described above. Furthermore, elastomers may be employed as the matrix or mixed with a polymer to provide the matrix. Other examples of polymers that may be used include an ethylene (meth)acrylic acid ionomer (such as HPF resin manufactured by DuPont), a polyether block amide (such as PEBAX® resin manufactured by Arkema Group), urethane/polyurethane, and/or polybutadiene.

In one embodiment, mantle layer 1020 is formed from a polymer material, such as one or more of ethylene (meth)acrylic acid ionomers (such as DuPont's HPF™ resin), polyether block amide (such as the material sold under the trade name PEBAX® made by the Arkema Group), polybutadiene, or other materials known in the art for use in golf balls. It should be understood that this is an illustrative, non-limiting example of the mantle layer composition.

Cover layer 1040 has outer surface 1050 and an inner surface, which together define a thickness, which is about 4 mm, but which may be any thickness from about ½ mm to about 6 mm. Outer surface 1050 has a surface dimple pattern and can be made of an ionomer resin (such as SURLYN® manufactured by DuPont), but may be also be made from other ionomers, urethanes, balata, polybutadienes, other synthetic elastomers, or any other material suitable for a golf ball cover as is known in the art. Cover layer 1040 also functions to provide the golf ball diameter, which can be 42.67 mm (1.68 inches), to meet USGA and industry standards, but may be any diameter equal to, greater than, or less than 42.67 mm. For example, the diameter may be from about 40 mm to about 45 mm, including all values and intermediary ranges therebetween.

Referring now to FIG. 2, an improved golf ball designated generally as 1100 includes a spherical core 1110, surrounded by a first mantle layer 1120, a second mantle layer 1130 superposed about, and in registration with, first mantle layer 1120, onto which a particulate material is deposited to form a particulate layer 1140, and a cover layer 1150 positioned over particulate layer 1140. An outer surface 1160 of cover layer 1150 may include surface features such as dimples and coatings to increase flight characteristics and improve durability, for example. First mantle layer 1120 can be referred to as an innermost mantle layer and second mantle layer 1130 can be referred to as an outermost mantle layer.

In one embodiment of golf ball 1100, first mantle layer 1120 is formed from a polymer material, such as one or more of ethylene (meth)acrylic acid ionomers, polybutadiene, while second mantle layer 1130 is comprised of a material that has at least one material characteristic different than that of first mantle layer 1120. In one illustrative embodiment, second mantle layer 1130 generally has an outside diameter from about 1.52 inches to about 1.60 inches (about 3.86 centimeters to about 4.06 centimeters) and a thickness from about 0.05 inches to about 0.65 inches (about 0.13 centimeters to about 1.65 centimeters), including all values and intermediary ranges therebetween. In another illustrative example, second mantle layer 1130 has an outside diameter from about 0.21 inches to about 0.55 inches (about 0.53 centimeters to about 1.4 centimeters), including all values and intermediary ranges therebetween.

Referring now to FIG. 3, an improved golf ball designated generally as 1200 includes a spherical core 1210, surrounded by a first mantle layer 1220, onto which a particulate material is deposited to forma particulate layer 1230, a first cover layer 1240 positioned over, and registered against, particulate layer 1230, and a second cover layer 1250 positioned over, and registered against, first cover layer 1240. An outer surface 1260 of cover layer 1250 may include surface features such as dimples and coatings to increase flight characteristics and improve durability, for example.

Referring now to FIG. 4, a golf ball designated generally as 1300 includes a spherical core 1310 surrounded by a first mantle layer 1220. A second mantle layer 1230 is positioned about, and registered against, first mantle layer 1220. A particulate material is deposited onto an outer surface of second mantle layer 1230 to form a particulate layer 1240. A cover layer 1250 is positioned about, and registered against, particulate layer 1240.

For any of the golf ball constructions shown in FIGS. 1-4, the stiffness of the spherical core and of the mantle layers affects the playing performance of the golf balls. The stiffness of a spherical core can be used as a design factor to control the Coefficient of Restitution (COR) and other performance characteristics of a golf ball. A designer can control COR by controlling the stiffness of the hard sphere, while creating a design regime that allows for fewer hooks and slices during play.

The stiffness of a spherical core is controlled through material selection and design. The golf balls disclosed herein include layers having controlled material sets along with a specialized particulate layer that imparts an increased moment of inertia that provides improved performance characteristics including low side spin rate, long distance, and bite without adversely affecting rebound characteristics. The design of the golf ball allows variations in the material and the size of the spherical core, second or other additional layers, and outer cover in order to optimize performance characteristics.

The stiffness of the spherical core of the golf ball may be attributed to either the properties of the material used to construct the sphere, such as the hardness, modulus of elasticity, toughness, etc., or properties associated with the shape and size of the sphere, such as the moment of inertia, the section modulus, etc. In addition, the properties of the polymers or other materials used to form the layers surrounding the sphere, as well as any materials within the sphere, affect the golf ball performance. The vibrational and other physical effects that occur in a golf ball after being struck will generally reduce the kinetic energy from the impact through lost to heat, thereby effecting the COR of the ball. Another parameter that plays a role in the vibrational response of a golf ball is the ball's ability to dampen the vibrations caused by impact. Damping may be attributed to the properties of the materials surrounding or disposed within the sphere, such as the density, viscosity, modulus of elasticity, coefficients of restitution, etc., of the materials. Additionally, the state of the materials is also a consideration, such as whether the materials are prestressed, etc. Any one of these parameters may be modified to tailor the vibrational response of a golf ball.

In addition to playing characteristics, durability is a key design consideration for golf balls. The normal force at impact between a golf ball and a golf club when the average golfer strikes the ball can be on the order of 2000 lbs. Thus, durability of the materials in a golf ball must be able to withstand this impact force many times while retaining their original shape following impact and without degradation of the ball's COR. For golf balls with several layers and particulate material layers, achieving a golf ball with good energy transfer between layers and sufficient durability is important.

The transfer of useful energy upon impact between the layers may be reduced due to the fracturing or other degradation of individual or multiple layers. One contributing factor for this degradation is differential elastic modulus between layers. In one embodiment, the layers are designed such that the elastic modulus of each layer or core is within three, two, or one-and-a-half orders of magnitude of each adjacent layer or core.

For particulate materials, the elastic modulus of the resulting layer may be significantly lower than the adjacent layers. In some cases, the layer may deform in a suitable manner, but the risk of cracks and other permanent deformation/damage is high, including specific design features to minimize the risk may be warranted in some embodiments. In one embodiment, the elastic modulus of the polymeric/elastomeric materials is selected such that there is a transition between certain layers or from the core through the last the polymeric/elastomeric layer, including or excluding the cover. The transition is such that the modulus difference between each contacting layer is not greater than some predetermined value. For example, in one embodiment the modulus difference between each contacting layer is not greater than one order of magnitude. Molding materials in several steps to produce a multi-component ball with several layers, where each layer is formed of a different combination of materials and/or using processing conditions to form such layers can result in decreasing stiffness from each layer moving between the core and the cover. The selection for each layer will generally be determined through experimental and modeling means, testing each layer individually, as well as variations of completed balls. In one embodiment, the particulate layer is not considered in the transitioning design and the layers on each side of the particulate layer are designed to meet the transitioning target level. This is because the elastic modulus of the particulate layer may be very low, or not measurable, which may be due to the deposition technique used.

It also is possible to provide multiple particulate layers between conventional golf ball layers, i.e., core, mantle, cover, to provide an elastic modulus transition zone between layers having significant differences in elastic modulus. Each particulate layer can be formulated to have a different elastic modulus. The particulate layer with the lowest elastic modulus can be positioned adjacent the conventional golf ball layer, e.g., the core, having the lowest elastic modulus of the conventional layers. The particulate layer with the highest elastic modulus can be positioned adjacent the conventional golf ball layer, e.g., the cover, having the highest elastic modulus of the conventional layers. The elastic moduli of the two particulate layers will be between the elastic modulus levels of the adjacent conventional layers so as to create a less abrupt difference in elastic modulus. By incorporating multiple-layer particulate layers, the elastic modulus transition between conventional layers can be made more gradual to improve golf ball durability. In an illustrative, non-limiting example, in a three-piece ball having a core, mantle and cover, the cover is formulated to have a flexural modulus between 10,000 and 30,000 psi. The mantle layer is formulated to have a flexural modulus between 55,000 and 70,000 psi. A particulate layer formed from a heavy-weight filler and a liquid adhesive is formulated to have a flexural modulus from about 31,000 to about 50,000 psi.

It is further within the scope of the disclosure to have more than one particulate layer formed in a golf ball. By way of nonlimiting example, a conventional four-piece ball may have a particulate layer between a core and an inner mantle layer. A second particulate layer can be positioned between the inner mantle layer and an outer mantle layer and/or a cover. Each particulate layer between the conventional layers also may be formed from multiple particulate layers, each having a different elastic modulus and/or density. In this manner particulate layers having relatively high densities as compared to other included particulate layers may be positioned under the cover to maximize moment of inertia effects. By modifying the particulate layer(s) formulation(s), peripheral weighting as well as elastic modulus transitions between conventional golf ball layers can be optimized to provide a durable golf ball with improved playing characteristics.

For application of the particulate materials, systems and methods for particulate material deposition onto layers of the golf ball and formation of the particulate layer(s) as illustrated in FIGS. 1 through 4 are described. Selected types of particulate materials having uniform properties may be accomplished and may be applied efficiently and cost effectively. The particulate materials may have a high density and provide a means to modify the moment of inertia of golf balls incorporating such materials. A golf ball with an increased moment of inertia may provide benefits in play such as a reduction in spin and resulting increase in distance in certain cases. In addition, golf balls of the disclosure produced with an increase in moment of inertia provides increased spin retention, and may provide for improved “bite’ around the greens. Such golf balls combine the favorable characteristics of existing golf balls.

In one embodiment, the particulate material serves as a design tool to modify the density at a predetermined surface layer within a golf ball. In some embodiments, high density particulate materials provide a means to increase the moment of inertia of a golf ball when compared to a golf ball produced with an identical configuration, except without the particulate layer. Another feature of particulate layers is the ability to measure the mass of the spherical body prior to its application, such that the mass of the ball can be fabricated in a way to bring it closer to the maximum mass allowed by the USGA. A golf ball with a mass near the maximum will generally fly further than an equivalent ball that has less mass.

In one embodiment, a mixture of adhesive and particulate material is combined and then applied to the desired layer, or layers, of the spherical body of the golf ball, prior to fabrication of additional layers (if any) and the cover layer. This mixture is called a self-adhering particulate formulation and can be applied by various means. In one embodiment, the self-adhering particulate formulation is placed into a paint spray apparatus designed to apply slurry materials to various surfaces. The self-adhering particulate formulation may require dilution with a solvent compatible with chosen adhesive such that the mixture has a viscosity that is compatible with the paint spraying apparatus. After the formulation is completed, compressed gas (compressed air, nitrogen, or other suitable gas) is delivered to the spray-painting apparatus and directed through an internal venturi-type flow device that creates a vacuum to pull the self-adhering particulate formulation into the flow line and then discharge a mixture of gas and self-adhering particulate formulation out of the spray-painting apparatus.

The discharged mixture of gas and self-adhering particulate formulation is directed at the spherical body where a fraction of the discharged material will impact the spherical body and deposit a fraction of the self-adhering particulate formulation onto the exposed surface. The spherical body may be mounted on a coatings fixture and rotated. Means to apply a liquid surface coating to golf balls (i.e., clear coats) is a well-known art and ball mounting and rotation equipment exists. In addition, a means to remove unused fractions of solvents, adhesives, and other possible chemicals by exhausting equipment is also well known.

Controlling the amount of mass of particulate that is deposited onto the surface of the spherical body can be accomplished by several means, which can be used together or independently:
(1) the amount of time the discharge is directed at the spherical body;
(2) the distance between the spray coating apparatus discharge nozzle and the spherical body;
(3) the fraction of mass of particulate material compared to the mass of adhesive and solvent that make up the self-adhering particulate formulation;
(4) the ratio of mass flow rate of gas flowing through the spray coating apparatus compared to the amount of particulate material flowing through the spray coating apparatus; and
(5) the overall fraction of the amount of applied particulate compared to the total amount of particulate discharged per unit time.

Formulation of the self-adhering particulate formulation, coating times, and spray distance can be easily controlled and modified as needed to reach a desired coatings level. The ratio of gas to self-adhering particulate formulation can be controlled by various means available on the spray equipment, as is well known in the art of spray application equipment. For example, the supplied gas pressure, the nozzle diameter, and internal flow restrictions can all be modified during setup to achieve desired outcome of coating deposition rates.

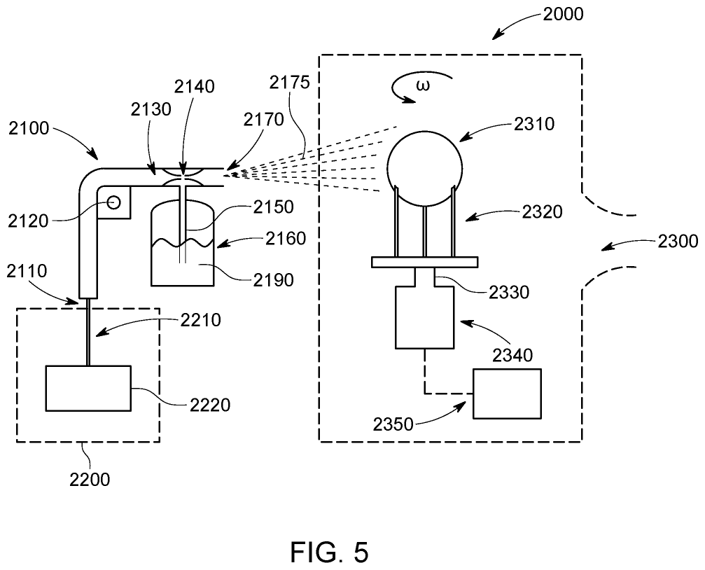

Referring now to FIG. 5, one example of a spray coating system designated generally as 2000 includes a spray coating apparatus 2100, onto which a gas connection 2110, trigger mechanism 2120, primary flow tube 2130, venturi 2140, slurry feed tube 2150, slurry container, designated generally as 2160, and discharge nozzle 2170 are attached. Spray coating apparatus 2100 is fed compressed gas from a gas compression system 2200 through a gas supply line 2210 generated by a gas compressor 2220. Spray coating apparatus 2100 is directed at a ball holding system 2300, including spherical body 2310 that comprises a golf ball at a certain stage of manufacture, such that the desired layer for particulate coating is exposed. The ball holding system 2300 further comprises a device to hold the spherical body 2310 such as a 3-prong ball holder 2320. Ball holder 2320 is designed to minimize contact area between the holding device and the spherical body 2310 such that coatings can be applied to a maximum coverage on the spherical body 2310. A motor shaft 2330 from a ball rotating motor 2340 is connected to the ball holder 2320 to allow the spherical body 2310 to be rotated. A motor controller 2350 is connected electronically to the ball rotating motor 2340 to allow control of the speed, timing, and other features of the rotation of the spherical body 2310 before, during, and after particulate material 2200 is applied.

Ingredients comprising the mixture to be filled (the spray slurry 2175) into slurry container 2160 and applied to the spherical body 2310 and that ultimately form the particulate material layer(s) are selected so as to provide the desired performance and application characteristics. In relation to performance, coatings of the particulate material should generally be durable and exhibit good compatibility with the layers of the ball to which it will contact, as well as exhibit acceptable mechanical properties, e.g., hardness, flexibility or resistance to mechanical impact as required for performance of the finished golf ball. I composition should be capable of forming a coherent layer on the applied substrate, and suitable flow and levelling of the composition on the substrate are required to produce a golf ball with the desired performance characteristics. In one embodiment, a film-forming binder resin is selected as the adhesive and optional crosslinker are used in the formulation, along with additives such as, for example, flow-promoting agent, plasticizer and a stabilizer. Additional optional additives include a temperature stabilizer to protect during subsequent ball layer manufacturing, and anti-gassing agent. Consideration about what additives to include depends upon the characteristics desired to be present or enhanced including enhancement of toughness and texture, for example.

In one embodiment, the apparatus of FIG. 5 is used to supply a liquid-based adhesive to form an adhesive base layer onto the predetermined conventional layer of spherical body 2310. In this embodiment, the liquid may or may not contain a slurry, i.e., with some solids contained therein. With an adhesive base layer applied to the spherical body layer, a dry particulate solid may be applied to the adhesive base layer before the adhesive layer has cured.

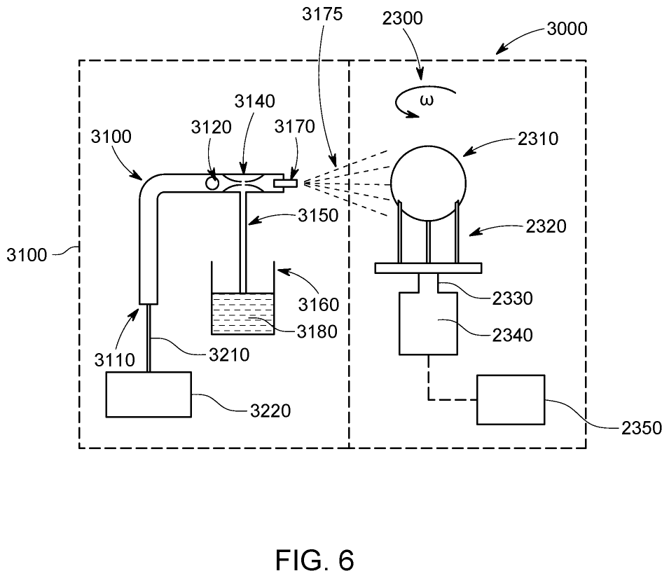

Referring now to FIG. 6, a powder coating system designated generally as 3000 includes a powder coating apparatus 3100, onto which a gas connection 3110, a trigger mechanism 3120, a primary flow tube 3130, a venturi 3140, a powder feed tube 3150, a dry powder container 3160, and a discharge nozzle 3170 are attached. Powder coating apparatus 3100 is fed compressed gas from a gas compression system 3200 through a gas supply line 3210, that is generated by a gas compressor 3220. The powder coating apparatus 3100 is aimed at a ball holding system 2300, including spherical body 2310, which comprises a golf ball at a certain pre-final stage of manufacturer, such that the desired layer for particulate coating is exposed. Ball holding system 2300 further comprises a further component to hold spherical body 2310, such as a 3-prong ball holder 2320. Ball holder 2320 is structured to minimize contact area between the holding device and spherical body 2310 such that coatings can be applied to a maximum coverage on spherical body 2310. A motor shaft 2330 from a ball rotating motor 2340 is connected to ball holder 2320 to allow spherical body 2310 to be rotated. A motor controller 2350 is connected electronically to ball rotating motor 2340 to allow control of the speed, timing, and other controllable features of the rotation of spherical body 2310 before, during, and after powder material 2200 is applied.

In the embodiment shown in FIG. 6, dry particles 3180 are entrained into the feed line and applied directly onto the surface of the spherical body. Using separate adhesive and particulate application stations allows for precise control of the amount of adhesive and particulate applied to the spherical body.

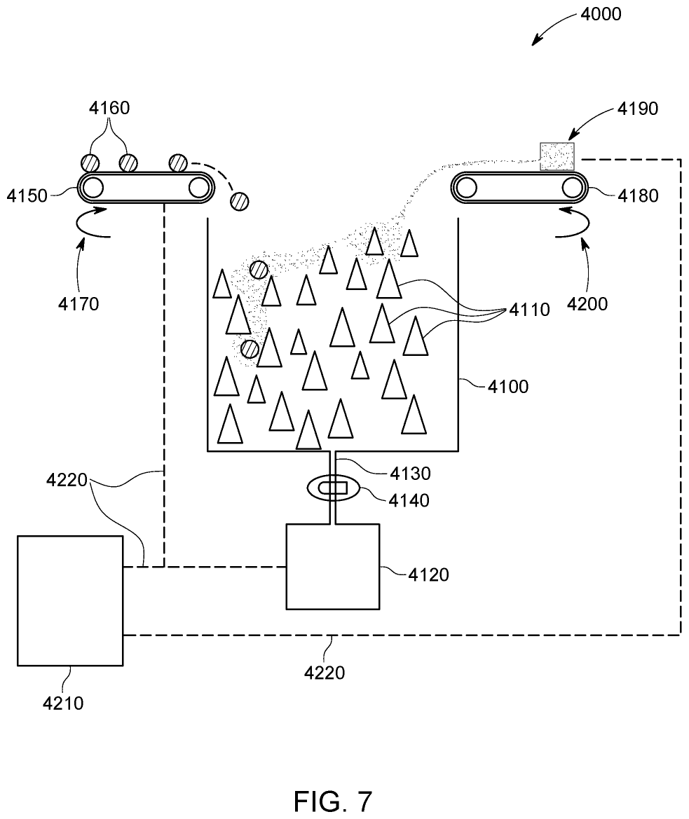

Referring now to FIG. 7, a powder coating system designated generally as 4000 includes a vibratory processing tank 4100, into which a process media 4110 is disposed. The vibratory processing tank 4100 is caused to vibrate, and optionally rotate, through a primary motor 4120, which is connected to the vibratory processing tank 4100 through a connection shaft 4130, including a gear control box 4140. A ball core delivery conveyor 4150 is positioned near the vibratory processing tank 4100 so that golf ball cores 4160 can be delivered into the vibratory processing tank 4100 at a predetermined rate by rotating the core delivery conveyor 4150 in the indicated delivery rotational direction 4170. At a position separate from the core delivery conveyor 4150 located near the vibratory processing tank 4100, a particulate delivery conveyor 4180 is positioned so that particulate coating material 4190 can be delivered into the vibratory processing tank 4100 at a predetermined rate by rotating the particulate delivery conveyor 4180 in the indicated delivery rotational direction 4200. An electronic controller 4210 is connected electronically though electrical wiring 4220 to the primary motor 4120, core delivery conveyor 4150, and particulate delivery conveyor 4180 to allow control of the speed, timing, and other controllable features of these devices before, during, and after particulate coating material 4190 is applied.

In one embodiment, spray adhesive is first applied to the golf ball cores prior to delivery into the vibratory processing tank 4100. In an alternative embodiment, adhesive material may be separately added into the vibratory processing tank 4100 simultaneously with the addition of particulate and golf ball cores.

Golf balls cores enveloped with particulate coating can be removed from the vibratory processing tank 4100 manually or by automated process. In an illustrative, non-limiting example, some commercially available vibratory processing tanks 4100 are designed to move the entire contents of the tank in a pre-determined motion. In one embodiment, the motion is a circular motion clockwise or counterclockwise around the center of the vibratory processing tank 4100 such that golf ball cores can be deposited into the tank at one location and removed after a pre-determined fraction of rotation has occurred. In another embodiment, newly coated ball cores are removed by using a screening process that uses a screen material with openings smaller than the diameter of the golf ball cores, but larger than the largest media, such that the media material passes thru and golf ball cores are retained and brought out of the vibratory processing tank 4100. In another embodiment, a screen size can be used such that cores as well as some or all media is removed as well, with ball cores being separated from the process media 4110 in a subsequent process.

In another embodiment, particulate material is applied to an adhesive-coated layer on the spherical body through dusting the balls in a fluidized bed. In yet another alternative embodiment, the golf ball layer to be coated is placed in a vibratory mixer that contains the desired particulate material.

A nonlimiting, illustrative example of a golf ball made according to the present disclosure is shown below:

### Example 1

Three-piece ball plus particulate material layer: polybutadiene spherical core with an outside diameter of 1.000 inches, surrounded by a mantle layer of DuPont HPF 1000 with a thickness of 0.480 inches, which is surrounded with an ionomer cover layer with a thickness of 0.060 inches. The particulate material is disposed over the mantle layer.

The general process for production includes:
Compression molding of a spherical core of polybutadiene rubber;
Injection molding of a polymeric mantle layer over the formed polybutadiene spherical core;
Spray coating 10 milligrams of urethane based adhesive layer onto the mantle layer;
Spray coating 100 milligrams of −325 mesh tungsten particulate onto the adhesive coated layer; and,
Injection molding a Surlyn cover over the spherical body.

Although the disclosure has been described with respect to one or more particular embodiments, it will be understood that other embodiments that do not provide all of the benefits and features set forth herein, may be made without departing from the scope of the disclosure. Various structural or process step changes may be made without departing from the scope of the disclosure. Accordingly, the scope of the disclosure is defined only by reference to the appended claims. Hence, the present disclosure is deemed limited only by the appended claims and any reasonable interpretation thereof.

What we claim as new and desire to secure by United States Letters Patent is:

1. A golf ball comprising:
a spherical core having an outer surface and a first flexural modulus;
an innermost mantle layer having an innermost mantle layer inner surface and an innermost mantle layer outer surface, wherein the innermost mantle layer inner surface registers against the outer surface of the spherical core, and wherein the innermost mantle layer has a second flexural modulus different than the first flexural modulus;
an outermost mantle layer having an outermost mantle layer inner surface and an outermost mantle layer outer surface, wherein the outermost mantle layer inner surface registers against the outermost mantle layer outer surface, and wherein the outermost mantle layer has a third flexural modulus different than the first and second flexural moduli;
a particulate material layer deposited on the outermost mantle layer outer surface, wherein the particulate material layer has a fourth flexural modulus less than the third flexural modulus; and,
a cover layer having an outer surface defining a plurality of dimples and an inner surface opposite the outer surface, wherein the inner surface registers against the particulate material layer, wherein the cover layer has a fifth flexural modulus less than the third and fourth flexural moduli.

2. The golf ball according to claim 1, wherein the fourth flexural modulus is between from about 31,000 to about 50,000 psi.

3. The golf ball of claim 2 wherein the third flexural modulus is between from about 55,000 psi and about 70,000 psi.

4. The golf ball of claim 3 wherein the fifth flexural modulus is between from about 10,000 psi and about 30,000 psi.

5. The golf ball of claim 1 wherein the particulate material is deposited to form structural or electronic functionality.

6. The golf ball according to claim 1, wherein the particulate material layer comprises at least 20% tungsten of the total particulate layer, wherein the particulate layer has a high density from about 2 grams per cubic centimeter (g/cc) to about 20 g/cc.

7. The golf ball according to claim 1, wherein the cover layer is fabricated from at least one of the materials selected from the group consisting of an ionomer resin, urethane, balata, polybutadiene, or another synthetic elastomer, and combinations thereof, wherein the outermost mantle layer and the innermost mantle layer are fabricated from a polymer.

8. A golf ball comprising:
a spherical core having an outer surface and a first flexural modulus;
a mantle layer having a mantle layer inner surface and a mantle layer outer surface, wherein the mantle layer inner surface registers against the outer surface of the spherical core, and wherein the mantle layer has a second flexural modulus different than the first flexural modulus;
a particulate material layer deposited on the outermost mantle layer outer surface, wherein the particulate material layer has a third flexural modulus less than the second flexural modulus; and,
a cover layer having an outer surface defining a plurality of dimples and an inner surface opposite the outer surface, wherein the inner surface registers against the particulate material layer, wherein the cover layer has a fourth flexural modulus less than the second and third flexural moduli.

9. The golf ball according to claim 8 wherein the third flexural modulus is between from about 31,000 to about 50,000 psi.

10. The golf ball of claim 9 wherein the second flexural modulus is between from about 55,000 psi and about 70,000 psi.

11. The golf ball of claim 10 wherein the fourth flexural modulus is between from about 10,000 psi and about 30,000 psi.

12. The golf ball according to claim 8 wherein the particulate material layer comprises at least 20% tungsten of the total particulate layer, wherein the particulate layer has a high density from about 2 grams per cubic centimeter (g/cc) to about 20 g/cc.

13. The golf ball according to claim 8 wherein the cover layer is fabricated from at least one of the materials selected from the group consisting of an ionomer resin, urethane, balata, polybutadiene, or another synthetic elastomer, and combinations thereof, wherein the outermost mantle layer and the innermost mantle layer are fabricated from a polymer.

14. The golf ball according to claim 8 wherein the core is formed from at least one of the materials selected from the group consisting of carbon fiber and/or glass filled plastics of any type commonly known in the art such as ABS, acetal, acrylic, polyamide, high impact polystyrene, phenolic resin, nylon, polycarbonate, polyester and combinations thereof.

15. The golf ball according to claim 8 wherein the mantle is formed from a polymer material, such as one or more of ethylene (meth)acrylic acid ionomers (such as DuPont's HPF™ resin), polyether block amide (such as the material sold under the trade name PEBAX® made by the Arkema Group), polybutadiene and combinations thereof.

16. A golf ball comprising:
a spherical core having an outer surface and a first flexural modulus;
a particulate material layer deposited on the outermost mantle layer outer surface, wherein the particulate material layer has a second flexural modulus less than the first flexural modulus; and,
a cover layer having an outer surface defining a plurality of dimples and an inner surface opposite the outer surface, wherein the inner surface registers against the particulate material layer, wherein the cover layer has a third flexural modulus less than the first and second flexural moduli.

17. The golf ball according to claim 16 wherein the second flexural modulus is between from about 31,000 to about 50,000 psi.

18. The golf ball according to claim 17 wherein the third flexural modulus is between from about 10,000 psi and about 30,000 psi.

19. The golf ball according to claim 16 wherein the particulate material layer comprises at least 20% tungsten of the total particulate layer, wherein the particulate layer has a high density from about 2 grams per cubic centimeter (g/cc) to about 20 g/cc.

20. The golf ball according to claim 16 wherein the cover is formed from TDI (Toluene Diisocyanate) or MDI (Methylene Diphenyl Diisocyanate) urethanes and cured with amine curatives.
